(19) United States
(12) Patent Application Publication
(10) Pub. No.: US 2014/0195777 A1
(43) Pub. Date: Jul. 10, 2014

(54) VARIABLE DEPTH INSTRUCTION FIFOS TO IMPLEMENT SIMD ARCHITECTURE

(71) Applicant: INTERNATIONAL BUSINESS MACHINES CORPORATION, Armonk, NY (US)

(72) Inventors: Mark D. Bellows, Rochester, MN (US); Mark S. Fredrickson, Rochester, MN (US); Scott D. Frei, Rochester, MN (US); Steven P. Jones, Rochester, MN (US); Chad B. McBride, North Bend, WA (US)

(73) Assignee: INTERNATIONAL BUSINESS MACHINES CORPORATION, Armonk, NY (US)

(21) Appl. No.: 13/738,239

(22) Filed: Jan. 10, 2013

(51) Int. Cl. G06F 15/80

(52) U.S. Cl. CPC G06F 15/8007
USPC 712/21

(57) ABSTRACT

In a particular embodiment, a method may include creating a plurality of variable depth instruction FIFOs and a plurality of data caches from a plurality of caches corresponding to a plurality of processors, where the plurality of caches and the plurality of processors correspond to MIMD architecture. The method may also include configuring the plurality of variable depth instruction FIFOs to implement SIMD architecture. The method may also include configuring the plurality of variable depth instruction FIFOs for at least one of SIMD operation, SIMD operation with staging, or RC-SIMD operation.

### FIELD OF THE DISCLOSURE

The present disclosure generally relates to execution of instructions on multiple processors.

### BACKGROUND

A computer typically includes a variety of resources, such as a processor, a main memory, and a data bus. The main memory typically includes instructions and data, and the processor executes the instructions using the data. The data bus may be used to access the main memory. Some computers include multiple processors for parallel processing of instructions.

However, sometimes multiple processors may compete for the same resource, such as the data bus, and a processor may be idle while it waits for the data bus. Furthermore, sometimes the data bus may be idle, and a processor may also be idle while it waits for the data bus. Indeed, inefficiencies may result from resource contention and under utilization of resources. The higher the number of processors, the higher the potential for inefficiencies.

### SUMMARY

In a particular embodiment, a method may include creating a plurality of variable depth instruction FIFOs and a plurality of data caches from a plurality of caches corresponding to a plurality of processors, where the plurality of caches and the plurality of processors correspond to MIMD architecture. The method may also include configuring the plurality of variable depth instruction FIFOs to implement SIMD architecture

In another particular embodiment, an apparatus may include a memory storing program code, and a processor configured to access the memory and execute the program code to create a plurality of variable depth instruction FIFOs and a plurality of data caches from a plurality of caches corresponding to a plurality of processors, where the plurality of caches and the plurality of processors correspond to MIMD architecture. The apparatus may also configure the plurality of variable depth instruction FIFOs to implement SIMD architecture.

In yet another particular embodiment, an apparatus may include a plurality of variable depth instruction FIFOs and a plurality of data caches created from a plurality of caches corresponding to a plurality of processors, including a first variable depth instruction FIFO, a second variable depth instruction FIFO, and a third variable depth instruction FIFO, and where the plurality of caches and the plurality of processors correspond to MIMD architecture. The apparatus may also include the first variable depth instruction FIFO configured to cascade an instruction within the first variable depth instruction FIFO and to cascade the instruction to the second variable depth instruction FIFO to implement SIMD architecture. The apparatus may also include the second variable depth instruction FIFO configured to cascade the instruction within the second variable depth instruction FIFO and to cascade the instruction to a third variable depth instruction FIFO to implement SIMD architecture.

These and other advantages and features that characterize embodiments of the disclosure are set forth in the claims listed below. However, for a better understanding of the disclosure, and of the advantages and objectives attained through its use, reference should be made to the drawings and to the accompanying descriptive matter in which there are described exemplary embodiments of the disclosure.

### BRIEF DESCRIPTION OF THE DRAWINGS

FIG. 1 is a diagram of a particular embodiment of MIMD architecture.

FIG. 2 is a diagram of a particular embodiment of SIMD architecture configured from the MIMD architecture of FIG. 1.

FIG. 3 is a diagram of a particular embodiment of SIMD operation.

FIG. 4 is a diagram of a particular embodiment of an apparatus with variable depth instruction FIFOs configured for SIMD operation.

FIG. 5 is a diagram of a particular embodiment of an apparatus with variable depth instruction FIFOs configured for SIMD operation with staging.

FIG. 6 is a diagram of a particular embodiment of a table for determining depth of a variable depth instruction FIFO.

FIG. 7 is a diagram of a particular embodiment of RC-SIMD operation.

FIG. 8 is a diagram of a particular embodiment of an apparatus with variable depth instruction FIFOs configured for RC-SIMD operation.

FIG. 9 is a flowchart of a particular embodiment of a method of executing an instruction.

FIG. 10 is a block diagram of an apparatus configured in a manner consistent with an embodiment.

### DETAILED DESCRIPTION

As described herein, a multiple instruction multiple data (MIMD) architecture may be configured to operate as single instruction multiple data (SIMD) architecture. For example, a cache of each processor core (e.g., processor or core) of MIMD architecture may be configured to include a variable depth instruction FIFO for instructions and a data cache for data. By doing so, MIMD architecture may operate as SIMD architecture, and SIMD type operation may occur on the SIMD architecture.

In particular, the variable depth instruction FIFOs may be utilized for SIMD operation and SIMD operation with staging, where instructions are executed at substantially the same time by each of the processor cores. The variable depth instruction FIFOs may also be utilized for reconfigurable single instruction multiple data (RC-SIMD) operation where instructions are delayed between processors. In particular, the variable depth instruction FIFOs may be configured to cascade (e.g., distribute) an instruction, including configuring a first variable depth instruction FIFO to cascade the instruction within the first variable depth instruction FIFO and to cascade the instruction to a second variable depth instruction FIFO. The second variable depth instruction FIFO may also cascade the instruction within the second variable depth instruction FIFO and to cascade the instruction to a third variable depth instruction FIFO, and so on. The plurality of variable depth instruction FIFOs may also adjust timing of an instruction to enable each processor core of the plurality of processor cores to receive the instruction at an appropriate time (e.g., substantially same time for SIMD operation and SIMD operation with staging, or delayed with RC-SIMD operation).

Additionally, as described herein, depths and tap depths of at least one variable depth instruction FIFO may be determined for SIMD operation, SIMD operation with staging, and RC-SIMD operation. Indeed, substantially optimal depths and tap depths of the variable depth instruction FIFOs may be determined for SIMD operation, SIMD operation with staging, and RC-SIMD operation. Moreover, as described herein, a number of processor cores may be determined for RC-SIMD operation. For example, a substantially optimal number of cores may be determined for RC-SIMD operation.

By configuring the MIMD architecture into the SIMD architecture, determining the depths, and/or determining the number of cores, efficiency may improve. For example, instances of resource contention and under utilization of resources may be reduced during SIMD operation, SIMD operation with staging, and RC-SIMD operation. Indeed, efficiency may be improved by reducing instances where the data bus is idle, as well as reduce instances where a processor core is idle.

Indeed, those of ordinary skill in the art may appreciate that, as described herein, a MIMD multiprocessor may be changed into a SIMD processor for applicable applications by using part of the processor caches for variable depth instruction FIFOs and by connecting the FIFOs in such a way that the instructions flow from one FIFO to the next. Moreover, by adjusting depths of the variable depth instruction FIFO and tap points connected to the next processor core, the SIMD architecture may be tuned for SIMD processing (e.g., with or without staging) or RC-SIMD processing (e.g., with or without staging).

For SIMD processing, the variable depth instruction FIFOs may be tuned such that all the processor cores are processing the same instruction at the same time, regardless of communication delays between the processor cores. For RC-SIMD processing, SIMD architecture may be tuned to make optimal use of a memory path with the fewest number of processor cores. Also, for RC-SIMD tuning, the depth “D” of the variable depth instruction FIFO for processor core [n] may be determined by letting the variable depth instruction FIFO grow during the time while processor core [n−1] is accessing memory. There may be other scenarios that may necessitate the dynamic growth or dynamic shrinking (e.g., reduction) of the variable depth instruction FIFO.

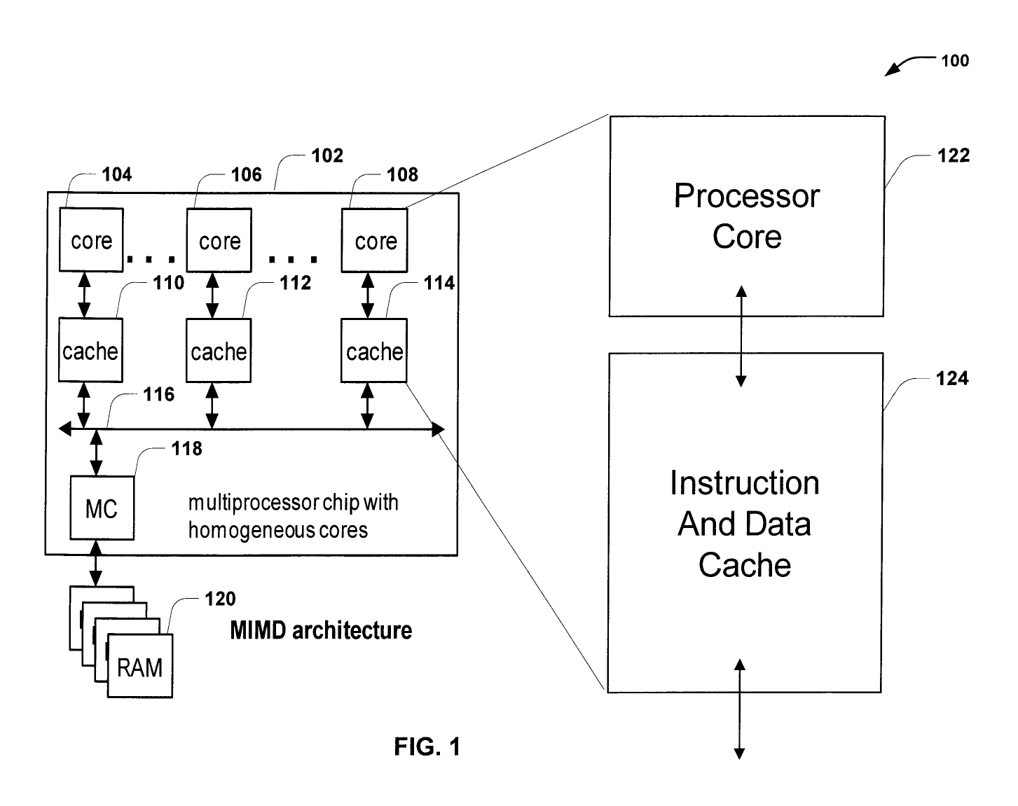

Turning to FIG. 1, this figure illustrates a diagram of a particular MIMD architecture that is generally designated as MIMD system 100. The MIMD system 100 may include a computer chip 102 (e.g., a multiprocessor chip) with multiple, homogeneous cores (e.g., processor cores) 104, 106, 108 that may each be capable of using a set of system resources available within the computer chip 102 to perform processing operation. Each of the cores 104, 106, 108 may be associated with a separate and distinct cache 110, 112, 114. For example, each of the caches 110, 112, 114 associated with the cores 104, 106, 108 may be a cache inside the core.

Each of the caches 110, 112, 114 may be coupled to a system input bus 116 of the computer chip 102. The system input bus 116 may include a data bus. Alternatively, the data bus may be a standalone bus or part of a memory bus. The system input bus 116 may be coupled to a memory controller (MC) 118 of the computer chip 102. The MC 118 may access main memory 120, such as random-access memory (RAM). The memory may be on board the computer chip 102 or remote from and coupled to the computer chip 102. The main memory 120 may include a set of instructions and data accessible by the MC 118.

In particular, each of the cores 104, 106, 108 may be similar to processor core 122, and each of the caches 110, 112, 114 may be similar to a cache 124. The cache 124 is an instruction and a data cache, and the instructions and the data are both accessed through the same cache. In operation, each of the caches 110, 112, 114 may receive instructions and data from the main memory 120 via the system input bus 116. The caches 110, 112, 114 may also provide the instructions and the data to the cores 104, 106, 108, respectively.

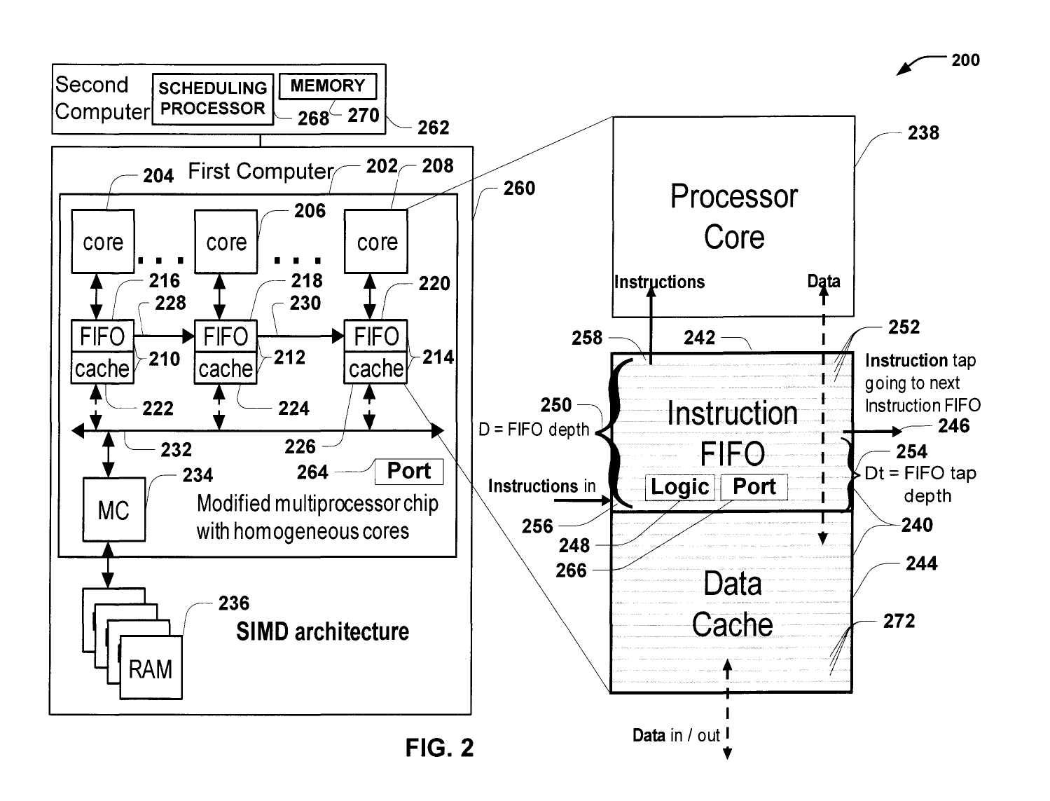

Turning to FIG. 2, this figure illustrates a diagram of a particular SIMD architecture configured from MIMD architecture (e.g., the MIMD architecture of FIG. 1), and is generally designated as SIMD system 200. The SIMD system 200 may include a computer chip 202 (e.g., a modified multiprocessor chip) with multiple, homogeneous cores (e.g., processor cores) 204, 206, 208 that may each be capable of using a set of system resources available within the computer chip 202 to perform processing operation. For example, the computer chip 202 may be a modified version of the computer chip 102 of the MIMD system 100 of FIG. 1.

Indeed, each of the cores 204, 206, 208 may be associated with a separate and distinct cache 210, 212, 214. However, each of the caches 210, 212, 214 may include a variable depth instruction FIFO, such as variable depth instruction FIFO 216, 218, 220, as well as a data cache, such as data caches 222, 224, 226. Moreover, a variable depth instruction FIFO tap 228 may allow instructions to flow from the variable depth instruction FIFO 216 to the variable depth instruction FIFO 218 at the appropriate time. A variable depth instruction FIFO tap 230 may allow instructions to flow from the variable depth instruction FIFO 218 to the variable depth instruction FIFO 220 at the appropriate time. The cores 204, 206, 208 and the caches 210, 212, 214 may be interconnected by cache control logic and interconnecting lines.

Each of the caches 210, 212, 214 may be coupled to a system input bus 232 of the computer chip 202. The system input bus 232 may include a data bus. Alternatively, the data bus may be a standalone bus or part of a memory bus. The system input bus 232 may be coupled to a memory controller (MC) 234 of the computer chip 202. The MC 234 may access main memory 236, such as random-access memory (RAM). The memory may be on board the computer chip 202 or remote from and coupled to the computer chip 202. The main memory 236 may include a set of instructions and data accessible by the MC 234.

In particular, each of the cores 204, 206, 208 may be similar to a processor core 238. Each of the caches 210, 212, 214 may be similar to a cache 240. The cache 240 may include a L1 cache, a L2 cache, a L3 cache, or any combination thereof. Each of the variable depth instruction FIFOs 216, 218, 220 may be similar to a variable depth instruction FIFO 242. Each of the data caches 222, 224, 226 may be similar to a data cache 244. Indeed, a portion of the cache 240 may be allocated as the variable depth instruction FIFO 242 and the rest of the cache 240 may operate as the data cache 244. Each of the variable depth instruction FIFO taps 228, 230 may be similar to a variable depth instruction FIFO tap 246.

Logic changes may be implemented to configure the SIMD architecture of FIG. 2 from the MIMD architecture of FIG. 1. For example, the cache 240 may include logic 248 (e.g., hardware logic, software logic, or both), which may reserve a portion of the cache 240 as the variable depth instruction FIFO 242. To accomplish this, the logic 248 may be configured to reallocate a portion of a L2 cache to the variable depth instruction FIFO 242 and to place a L1 instruction cache in a non-cacheable operation mode. Alternatively, the logic 248 may be configured to operate a L1 instruction cache as the variable depth instruction FIFO 242 with controls for adjusting the operational depth of the variable depth instruction FIFO 242. Each of the caches 210, 212, 214 may include the logic 248. Indeed, a small amount of additional logic may be added to a MIMD multiprocessor to convert it into an SIMD multiprocessor.

Furthermore, addressing changes may also occur to divide the cache 240 into the variable depth instruction FIFO 242 and the data cache 244, and to allow for addressing of the two portions. Alternatively, multi-port arrays may be utilized such that one port has a pointer into the variable depth instruction FIFO 242 and another port has a pointer into the data cache 244. Indeed, the cache 240 may be implemented with a memory array and the memory array may be used as variable depth instruction FIFO 242 or as the cache 240.

In addition to the logic changes, the variable depth instruction FIFO taps 228, 230 (e.g., similar to the variable depth instruction FIFO tap 246) may be added. Furthermore, wires connecting the variable depth instruction FIFOs 216, 218, 220, such that the instructions may be sent from one variable depth instruction FIFO to another variable depth instruction FIFO, may also be added.

Turning more specifically to the variable depth instruction FIFO 242, as illustrated by 250, “D” may equal the depth of the variable depth instruction FIFO 242. Moreover, the value of “D” may vary, for example, the value of “D” may be adjusted to control how many instructions may be stored in the variable depth instruction FIFO 242. For simplicity, it is assumed throughout this discussion that each cache line 252 of the variable depth instruction FIFO 242 holds a single instruction (e.g., one instruction), and each instruction takes about the same amount of time to be processed by the core 238. For example, a “D” with a value of four may indicate that the variable depth instruction FIFO 242 may store four instructions due to its depth of four. However, if the value of “D” is adjusted to nine, then the variable depth instruction FIFO 242 may have nine instructions, and so on. Those of ordinary skill in the art may appreciate that the assumption may or may not be used in other embodiments.

As illustrated by 254, “Dt” may be the tap depth of the variable depth instruction FIFO tap 246. In particular, instructions may flow into a head 256 of the variable depth instruction FIFO 242 and flow out of a tail 258 of the variable depth instruction FIFO 242 into the core 238. As such, the value of “Dt” may indicate the number of cache lines in the variable depth instruction FIFO 242 between the head 256 and the variable depth instruction FIFO tap 246. Like “D,” the value of “Dt” may also vary. Thus, the variable depth instruction FIFO tap 246 may be adjustable and used to pass instructions from one variable depth instruction FIFO to another variable depth instruction FIFO, as appropriate.

In operation, the computer chip 102 of FIG. 1 may be manufactured with the appropriate logic 248 for each of the caches 210, 212, 214 and the wires connecting the variable depth instruction FIFOs 216, 218, 220, resulting in the computer chip 202 of FIG. 2. As such, the computer chip 202 may be configured for SIMD architecture from MIMD architecture.

Furthermore, the values of “D” and “Dt” may be determined for each of the variable depth instruction FIFOs 216, 218, 220. The computer chip 202 may be included in a first computer 260, and a core of the computer chip 202 (e.g., the core 204 with or without the variable depth instruction FIFO 216) or other processor of the first computer 260 may be utilized for scheduling and distributing workloads (e.g., multimedia workloads such as imaging processing). As such, the scheduling core of the computer chip 202 or the scheduling processor of the first computer 260 may execute program code to determine the values of “D” and/or “Dt” for each of the variable depth instruction FIFOs 216, 218, 220 in the SIMD architecture. Indeed, the values of “D” and/or “Dt” may be determined for each of the variable depth instruction FIFOs 216, 218, 220 for SIMD operation, SIMD operation with staging, and RC-SIMD in the SIMD architecture. Substantially optimal depths of the variable-depth instruction FIFO's may be determined for SIMD operation, SIMD operation with staging, and RC-SIMD operation in the SIMD architecture.

Furthermore, the scheduling core of the computer chip 202 or scheduling processor of the first computer 260 may execute program code to determine a number of cores to use for RC-SIMD operation in the SIMD architecture. For example, a substantially optimal number of cores may be determined for RC-SIMD operation in the SIMD architecture. As an example, a particular computer may have ten processor cores, and an optimal number of processor cores to use for a particular workload may be less than ten or may be ten. If the optimal number determined is two processor cores, then a third processor core may be idle.

Alternatively, the first computer 260 may be coupled to a second computer 262. The second computer 262 may have practically any architecture, and may include a scheduling processor 268 and a memory 270. The scheduling processor 268 of the second computer 262 may execute program code to determine the values of “D” and/or “Dt” for each of the variable depth instruction FIFOs 216, 218, 220 in the SIMD architecture. Indeed, the values of “D” and/or “Dt” may be determined by the scheduling processor 268 for each of the variable depth instruction FIFOs 216, 218, 220 for SIMD operation, SIMD operation with staging, and/or RC-SIMD operation in the SIMD architecture. Indeed, substantially optimal depths of the variable depth instruction FIFOs may be determined by the scheduling processor 268 for SIMD operation, SIMD operation with staging, and/or RC-SIMD operation in the SIMD architecture.

Furthermore, the scheduling processor 268 of the second computer 262 may execute program code to determine a number of cores to use for RC-SIMD operation in the SIMD architecture. For example, a substantially optimal number of cores may be determined by the scheduling processor 268 for RC-SIMD operation on the configured SIMD architecture.

The variable depth instruction FIFOs 216, 218, 220 and cores 204, 206, 208 may be configured by a scheduling processor of the first computer 260 based on the determined values. Alternatively, a port 264 of the computer chip 202 (or port 264 of a removable computer card (not shown) that includes the computer chip 202) may be configured to enable another computer system (e.g., the second computer 262) to access or configure the variable depth instruction FIFOs 216, 218, 220. Thus, the variable depth instruction FIFOs 216, 218, 220 and cores 204, 206, 208 may be configured by the scheduling processor 268 of the second computer 262 based on the determined values. Alternatively, or additionally, each of the variable depth instruction FIFOs 216, 218, 220 may include a port, similar to a port 266 of the variable depth instruction FIFO 242. In particular, the port 266 may be configured to enable another computer system (e.g., the second computer 262) to access or configure the corresponding variable depth instruction FIFO. For example, via ports 266, the variable depth instruction FIFOs 216, 218, 220 may be configured by the scheduling processor 268 of the second computer 262 based on the determined values. Indeed, the ports 264, 266 may support configuring, including disabling and/or enabling, of each of the variable depth instruction FIFOs 216, 218, 220 and/or each of the cores 204, 206, 208 responsive to the determined values of “D,” “Dt,” and number of cores.

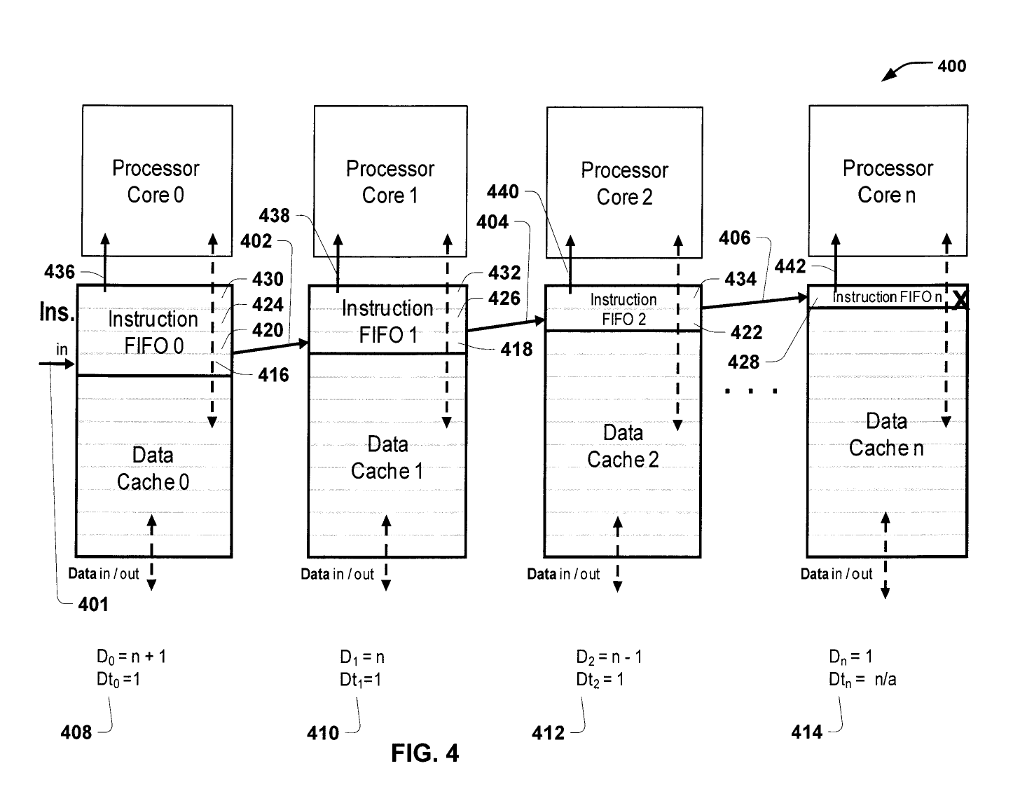

As such, the scheduling core of the computer chip 202, the scheduling processor of the first computer 260, or the scheduling processor 268 of the second computer 262 may determine the values of “D,” “Dt,” and/or the number of cores, as appropriate. The determined values may be based on the workload, the operation (e.g., SIMD operation, SIMD operation with staging, and/or RC-SIMD operation), etc. Determining values is discussed further hereinbelow in connection with FIGS. 4, 5, 6.

After the variable depth instruction FIFOs 216, 218, 220 have been configured with a value for “D” and a value for “Dt,” for example, instructions may enter the variable depth instruction FIFOs 216, 218, 220. Each instruction may come into a head of the variable depth instruction FIFOs 216, 218, 220 and exit out a tail of the variable depth instruction FIFOs 216, 218, 220 into the cores 204, 206, 208. For example, each instruction may come into the head 256 and advance one cache line 252 per cycle until the instruction reaches the tail 258 and is sent to the core 238 in a next cycle.

Moreover, the variable depth instruction FIFO tap 228 may allow each instruction to be sent from the variable depth instruction FIFO 216 to the variable depth instruction FIFO 218 at the appropriate time, and the variable depth instruction FIFO tap 230 may allow each instruction to be sent from the variable depth instruction FIFO 218 to the variable depth instruction FIFO 220 at the appropriate time. The timing may depend on the type of operation (e.g., SIMD operation, SIMD operation with staging, and/or RC-SIMD operation).

The cores 204, 206, 208 may execute each instruction received using data received from the data caches 222, 224, 226. For example, data may come into and out of the data cache 244, may be stored in cache lines 272 of the data cache 244 of the cache 240, and may come into and out of the processor core 238, as appropriate. By cascading instructions via variable depth instruction FIFOs, each core may receive substantially the same instructions as every other core in the SIMD architecture. Moreover, for SIMD operation and SIMD operation with staging, each core may execute substantially the same instruction at substantially the same time in lock step. For RC-SIMD operation, each core may execute substantially same instructions, but with some amount of time delay between each core.

Thus, those of ordinary skill in the art may appreciate that MIMD architecture may be converted into SIMD architecture, as described herein. Indeed, a MIMD computer may be reconfigured into a SIMD computer by utilizing part of the cache of each core as a variable depth instruction FIFO and cascading (e.g., distributing) instructions from an instruction FIFO of one core to the instruction FIFO of the next core, as well as cascading within the instruction FIFO. Moreover, multiprocessor computers may even be able to switch between SIMD and MIMD operation. Of note, the variable depth instruction FIFOs may be created from practically any cache of any architecture, such as MIMD architectures or practically any other architecture. As such MIMD architecture may include other architectures.

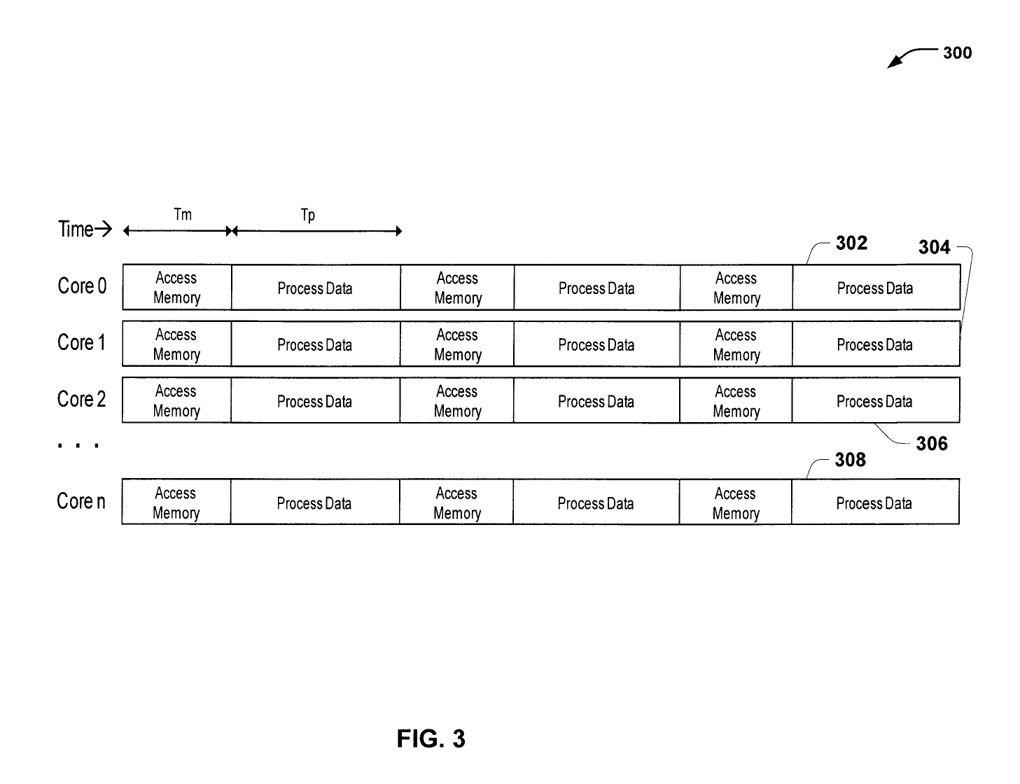

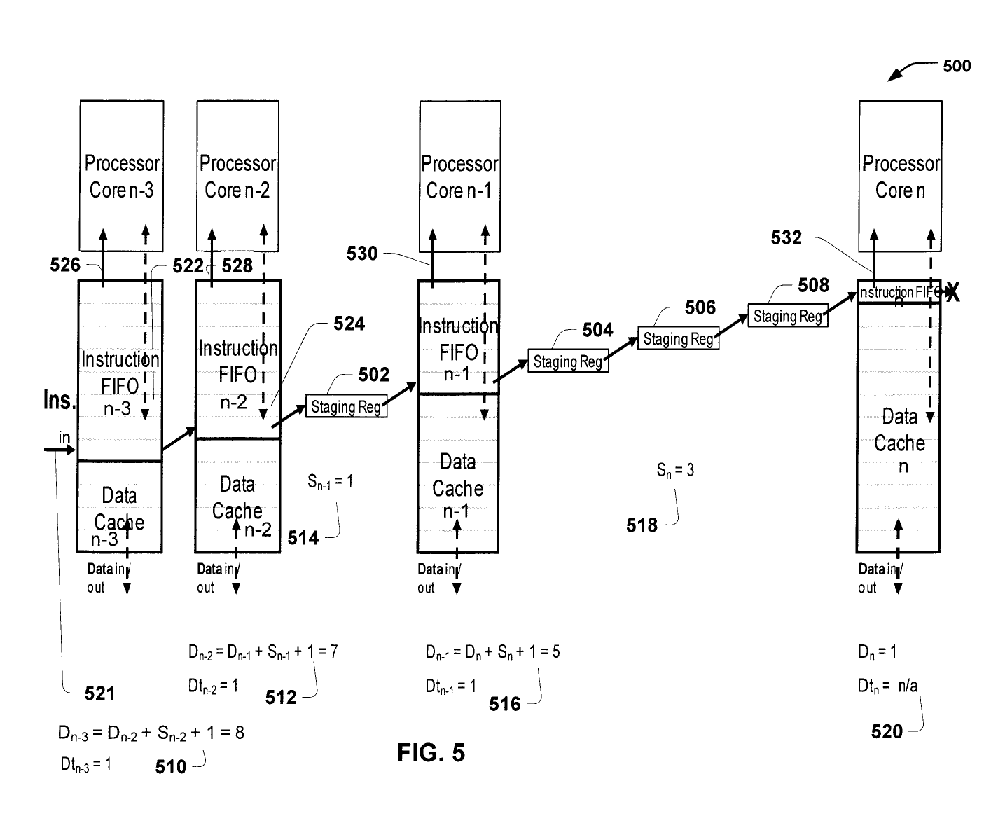

Turning to diagram 300 of FIG. 3, FIG. 3 is a particular embodiment of SIMD operation. In particular, cores [0] to [n] may each attempt to access memory simultaneously, as illustrated by sequences 302, 304, 306, 308. The term “Tm” may refer to a time it takes to access memory. The term “Tp” may refer to a time it takes to process data. For SIMD operation, Tm may refer to a time it takes all processor cores to access memory. Nonetheless, in SIMD operation (and SIMD operation with staging), memory access bottlenecks may potentially occur due to resource contention over the data bus. However, the SIMD architecture of FIG. 2 from the MIMD architecture of FIG. 1 along with the variable depth instruction FIFOs 242, 216, 218, 220 of FIG. 2 may reduce memory access bottlenecks in SIMD operation (and SIMD operation with staging), as explained further in connection with FIG. 4 (and FIG. 5).

Turning to diagram 400 of FIG. 4, FIG. 4 is a particular embodiment of an apparatus with variable depth instruction FIFOs configured for SIMD operation. In particular, each of the variable depth instruction FIFOs may have a depth that is tuned in a manner that substantially all corresponding cores execute each instruction at substantially the same time.

Each of the processor cores [0] to [n] of FIG. 4 may be similar to the processor cores 238, 204, 206, 208 of FIG. 2. Each of the variable depth instruction FIFOs [0] to [n] in FIG. 4 may be similar to the variable depth instruction FIFOs 242, 216, 218, 220 of FIG. 2. Each of the data caches [0] to [n] of FIG. 4 may be similar to the data caches 240, 210, 212, 214 of FIG. 2. Each of the variable depth instruction FIFO taps 402, 404, 406 of FIG. 4 may be similar to the variable depth instruction FIFO taps 246, 228, 230.

In operation, a number “n” of processor cores participating in the SIMD operation may be determined. As illustrated, four processor cores are participating in the SIMD operation, and as such, the value of “n” may be three (i.e., [0], [1], [2], and [3]). Furthermore, the depth “D” of each of the variable depth instruction FIFOs [0] to [n] may be determined, as illustrated in FIG. 4. Moreover, the variable depth instruction FIFO tap depth “Dt” of each of the variable depth instruction FIFOs [0] to [n] may be determined, as illustrated in FIG. 4. For example, for the variable depth instruction FIFO [0], D [0]=n+1 (i.e., D [0]=3+1=4) and Dt [0]=1, as illustrated at 408. Dt may equal 1 due to the assumption discussed hereinabove. For example, for the variable depth instruction FIFO [1], D [1]=n (i.e., D [1]=3) and Dt [1]=1, as illustrated at 410. For example, for the variable depth instruction FIFO [2], D [2]=n−1 (i.e., D [0]=3−1=2) and Dt [2]=1, as illustrated at 412. For example, for the variable depth instruction FIFO [n], D [n]=1 and Dt [n]=n/a, as illustrated at 414. The value of D may correspond to a number of cache lines of a variable depth instruction FIFO, and each of the variable depth instruction FIFOs [0] to [n] in FIG. 4 may have a different depth for SIMD operation, as illustrated in FIG. 4.

More specifically, at a first cycle, an instruction (e.g., an add or a load instruction) may come into a cache line 416 of the variable depth instruction FIFO [0] via a tap 401. The cache line 416 may be a head of the variable depth instruction FIFO [0].

At a second cycle, the instruction may be sent from the variable depth instruction FIFO [0] via the variable depth instruction FIFO tap 402 to cache line 418 of the variable depth instruction FIFO [1]. The cache line 418 may be a head of the variable depth instruction FIFO [1]. Moreover, at the second cycle, the instruction may advance to cache line 420 in the variable depth instruction FIFO [0].

At a third cycle, the instruction may be sent from the variable depth instruction FIFO [1] via the variable depth instruction FIFO tap 404 to cache line 422 of the variable depth instruction FIFO [2]. The cache line 422 may be a head of the variable depth instruction FIFO [2]. Moreover, at the third cycle, the instruction may advance to cache line 424 in the variable depth instruction FIFO [0] and the instruction may advance to cache line 426 in the variable depth instruction FIFO [1].

At a fourth cycle, the instruction may be sent from the variable depth instruction FIFO [2] via the variable depth instruction FIFO tap 406 to cache line 428 of the variable depth instruction FIFO [n]. The cache line 428 may be a head (and tail) of the variable depth instruction FIFO [n]. Moreover, at the fourth cycle, the instruction may advance to cache line 430 in the variable depth instruction FIFO [0], the instruction may advance to cache line 432 in the variable depth instruction FIFO [1], and the instruction may advance to cache line 434 in the variable depth instruction FIFO [2]. The cache lines 430, 432, 434 may be tails of the variable depth instruction FIFOs [0], [1], [2].

At a fifth cycle, each instruction in each of the variable depth instruction FIFOs [0] to [n] may pass to the processor cores [0] to [n] at substantially the same time for SIMD operation, as illustrated by 436, 438, 440, 442. Indeed, those of ordinary skill in the art may appreciate how the depths of each variable depth instruction FIFO varied appropriately to properly distribute the instruction to the variable depth instruction FIFOs, as well as to properly adjust timing of the instruction such that each processor core receives the instruction at the appropriate time (i.e., substantially the same time for the SIMD operation).

Additional instructions may be cascaded in a similar manner. The processor cores [0] to [n] (e.g., at least one processor core) may indicate when it is ready for the next instruction. For example, a processor core [n] may control the pop of instructions from the variable depth instruction FIFO [n] into processor core [n] and the push of instructions from variable depth instruction FIFO [n] to variable depth instruction FIFO [n+1]. These operation may happen at substantially the same time. In one embodiment, this may occur when processor core [n] finishes executing the preceding instruction and fetches the next one from the variable depth instruction FIFO [n]. In another embodiment, this may occur when the preceding instruction is dispatched inside processor core [n]. Furthermore, those of ordinary skill in the art may appreciate there may be no other synchronization between the processor cores [0] to [n]. The processor cores [0] to [n] may be kept in lock step due to running the same instructions.

Turning to diagram 500 of FIG. 5, FIG. 5 is a particular embodiment of an apparatus with variable depth instruction FIFOs configured for SIMD operation with staging. In particular, each of the variable depth instruction FIFOs may have a depth that is tuned in a manner that substantially all corresponding cores execute each instruction at substantially the same time in spite of staging registers.

In particular, the diagram 400 of FIG. 4 may be adjusted to accommodate the physical distance between the variable depth instruction FIFOs. For example, if variable depth instruction FIFO[n] is separated by a large distance from another variable depth instruction FIFO [n+1], at least one staging register may be inserted into the instruction distribution path between the variable depth instruction FIFO [n] and the variable depth instruction FIFO [n+1]. Moreover, the staging register or registers may be considered as part of the next variable depth instruction FIFO, and the depth of the next variable depth instruction FIFO may be reduced by the number of staging registers between the variable depth instruction FIFOs. For example, if two staging registers are added between the variable depth instruction FIFO [0] and FIFO [1], and D [0]=n+1, then D [1]=n−2, instead of D [1]=n. Nonetheless, processor cores may still execute instruction at substantially the same time under SIMD operation with staging.

The system 500 may be similar in arrangement and operation as the system 400 of FIG. 4, except that the system 500 may include staging registers 502, 504, 506, 508. The processor core [n−3] of FIG. 5 may be similar to the processor core [0] of FIG. 4 and so on. In operation, the depth “D” of each of the variable depth instruction FIFOs [n−3] to [n] may be determined as illustrated in FIG. 5. The variable depth instruction FIFO tap depth “Dt” of each of the variable depth instruction FIFOs [n−3] to [n] may be determined as illustrated in FIG. 5. The term “S” may refer to a staging register. For example, for the variable depth instruction FIFO [n−3], D [n−3]=D [n−2]+S [n−2]+1 (i.e., D [n−3]=7+0+1=8) and Dt [n−3]=1, as illustrated at 510. For example, for the variable depth instruction FIFO [n−2], D [n−2]=D [n−1]+S [n−1]+1 (i.e., D [n−2]=5+1+1=7) and Dt [n−2]=1, as illustrated at 512. As illustrated by 514, S [n−1]=1 to account for the staging register 502. For example, for the variable depth instruction FIFO [n−1], D [n−1]=D [n]+S [n]+1 (i.e., D [n−1]=1+3+1=5) and Dt [n−1]=1, as illustrated at 516. As illustrated by 518, S [n]=3 accounts for the staging registers 504, 506, 508. For example, for the variable depth instruction FIFO [n], D [n]=1 and Dt [n]=n/a, as illustrated at 520. The value of D may correspond to a number of cache lines of a variable depth instruction FIFO. Indeed, each of the variable depth instruction FIFOs [n−3] to [n] in FIG. 5 may have different depths, as illustrated in FIG. 5.

More specifically, at a first cycle, an instruction (e.g., an add or a load instruction) may come into a head of the variable depth instruction FIFO [n−3] via a tap 521. At a third cycle, the instruction may be in cache line 522 of the variable depth instruction FIFO [n−3], in a cache line 524 of the variable depth instruction FIFO [n−2], and in the staging register 502. At a fifth cycle, the instruction may be advancing in cache lines of the variable depth instruction FIFOs [n−3], [n−2], and [n−1] and in the staging register 504. At a sixth cycle, the instruction may be advancing in cache lines of the variable depth instruction FIFOs [n−3], [n−2], and [n−1] and in the staging register 506. At a seventh cycle, the instruction may be advancing in cache lines of the variable depth instruction FIFOs [n−3], [n−2], and [n−1] and in the staging register 508. At the eighth cycle, the instruction may be at the tail of each of the variable depth instruction FIFOs [n−3] to [n].

At the ninth cycle, each instruction in each of the variable depth instruction FIFOs [n−3] to [n] of FIG. 5 may pass to the processor cores [n−3] to [n] of FIG. 5 at substantially the same time consistent with SIMD operation with staging, as illustrated by 526, 528, 530, 532. Those of ordinary skill in the art may appreciate how the depths of each variable depth instruction FIFO varied appropriately to properly cascade the instruction to the variable depth instruction FIFOs, as well as to properly adjust timing of the instruction such that each processor core receives the instruction at the appropriate time (i.e., substantially the same time for the SIMD operation with staging).

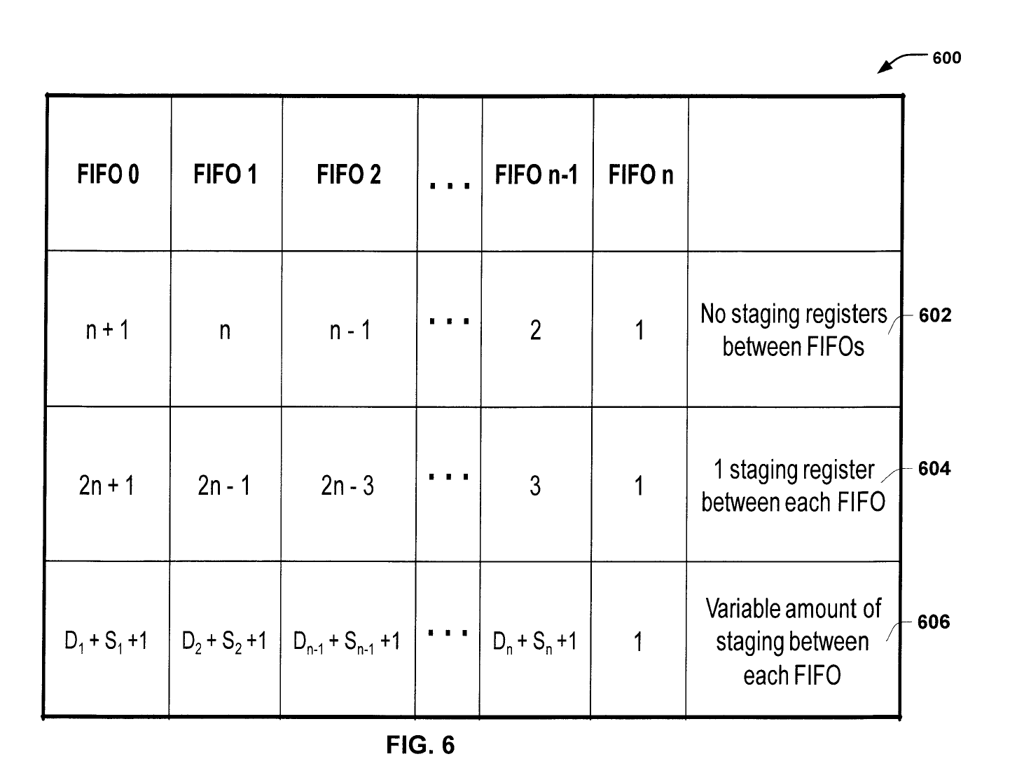

Turning to diagram 600 of FIG. 6, FIG. 6 is a particular embodiment of a table for determining depth of a variable depth instruction FIFO. For example, the diagram 600 may indicate how to determine minimum depths (e.g., about minimum depths) for variable depth instruction FIFOs for SIMD operation and SIMD operation with staging.

A row 602 may indicate how to determine depths of various variable depth instruction FIFOs without staging registers between the variable depth instruction FIFOs. Specifically, for a variable depth instruction FIFO [0], D [0]=n+1. For a variable depth instruction FIFO [1], D [1]=n. For a variable depth instruction FIFO [2], D [2]=n−1. For a variable depth instruction FIFO [n−1], D [n−1]=2. For a variable depth instruction FIFO [n], D [n]=1.

A row 604 may indicate how to determine depths of various variable depth instruction FIFOs where there may be one staging register between each of the variable depth instruction FIFOs. Specifically, for a variable depth instruction FIFO [0], D [0]=2n+1. For a variable depth instruction FIFO [1], D [1]=2n−1. For a variable depth instruction FIFO [2], D [2]=2n−3. For a variable depth instruction FIFO [n−1], D [n−1]=3. For a variable depth instruction FIFO [n], D [n]=1.

A row 606 may indicate how to determine depths of various variable depth instruction FIFOs where there may be a variable number of staging registers between each of the variable depth instruction FIFOs. Specifically, for a variable depth instruction FIFO [0], D [0]=D [1]+S [1]+1. For a variable depth instruction FIFO [1], D [1]=D [2]+S [2]+1. For a variable depth instruction FIFO [2], D [2]=D [n−1]+S [n−1]+1. For a variable depth instruction FIFO [n−1], D [n−1]=D [n]+S [n]+1. For a variable depth instruction FIFO [n], D [n]=1.

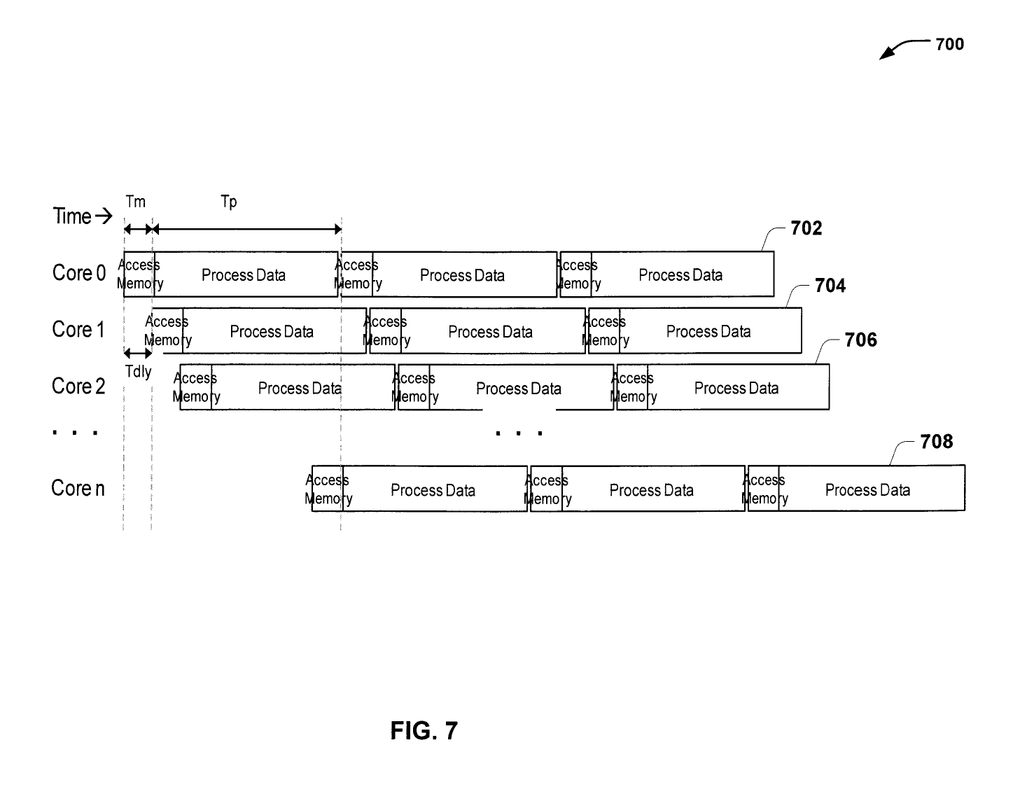

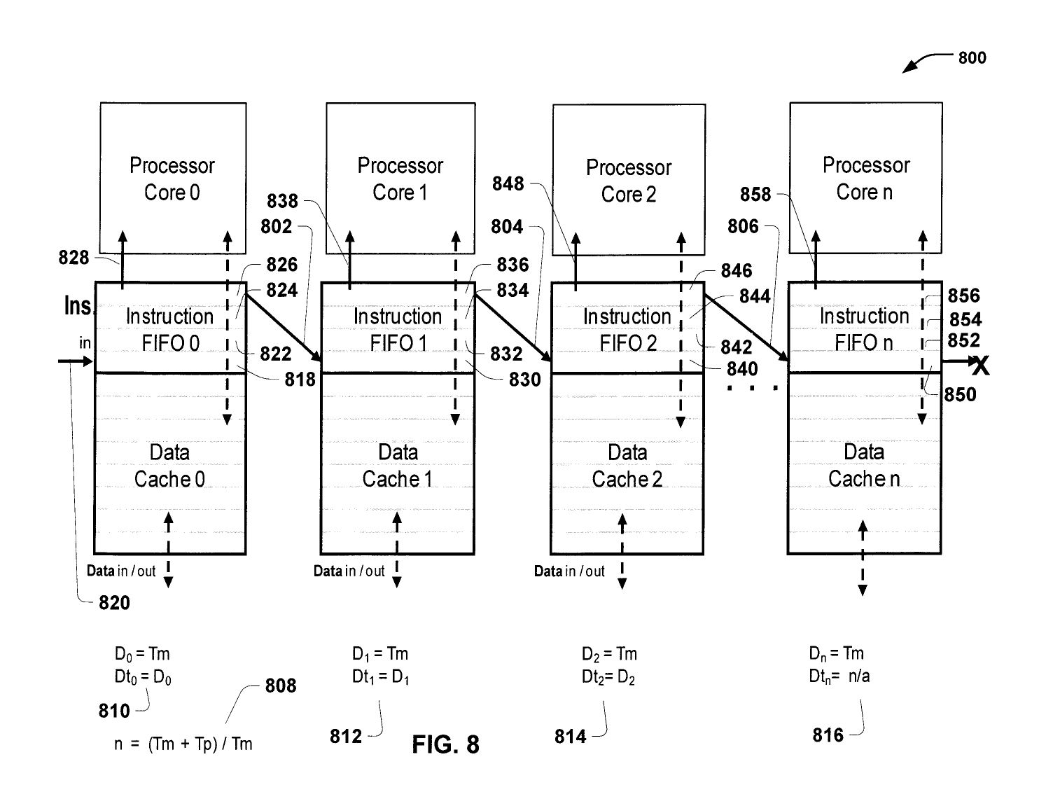

Turning to diagram 700 of FIG. 7, FIG. 7 is a particular embodiment of RC-SIMD operation. In particular, cores [0] to [n] may each attempt to access memory with a delay “Tdly,” as illustrated by sequences 702, 704, 706, 708. The term “Tm” may refer to a time it takes to access memory. The term “Tp” may refer to a time it takes to process data. The term “Tdly” may refer to a time delay of RC-SIMD operation, where the time delay may cause processor cores to not attempt to access memory simultaneously. Nonetheless, in RC-SIMD operation, one or more of processor cores [0] to [n] may be potentially idle. However, the SIMD architecture of FIG. 2 from the MIMD architecture of FIG. 1 along with the variable depth instruction FIFOs 242, 216, 218, 220 of FIG. 2 may reduce scenarios where processor cores are idle in RC-SIMD operation, as explained further in connection with FIG. 8.

Turning to diagram 800 of FIG. 8, FIG. 8 is a particular embodiment of an apparatus with variable depth instruction FIFOs configured for RC-SIMD operation. In particular, each of the variable depth instruction FIFOs may have a depth that is tuned in a manner that cores access memory in sequential fashion with a delay, instead of simultaneously.

Each of the processor cores [0] to [n] of FIG. 8 may be similar to the processor core 238, 204, 206, 208 of FIG. 2. Each of the variable depth instruction FIFOs [0] to [n] in FIG. 8 may be similar to the variable depth instruction FIFOs 242, 216, 218, 220 of FIG. 2. Each of the data caches [0] to [n] of FIG. 8 may be similar to the data caches 240, 210, 212, 214 of FIG. 2. Each of the variable depth instruction FIFO taps 802, 804, 806 of FIG. 8 may be similar to the variable depth instruction FIFO taps 246, 228, 230 of FIG. 2.

In operation, the number “n” of cores may be determined. As illustrated by 808, n=(Tm+Tp)/Tm. The term “Tm” may refer to a time it takes to complete a memory access. The term “Tp” may refer to a time it takes to process data. The values of Tm and Tp may depend on the workload. For example, the number of cores determined for workload X may be four cores. Indeed, four cores may be the optimal number of cores for workload X, as a fifth core may be idle and only three cores may lead to resource contention or other inefficiencies. However, the number of cores determined for workload Y may be three cores, as fourth and fifth cores may be idle. Indeed, four cores may be the optimal number of cores determined for the workload of FIG. 4, and the processor cores [0] to [n] of FIG. 8 are those four cores.

The depth “D” of each of the variable depth instruction FIFOs [0] to [n] may be determined, as illustrated in FIG. 8. The variable depth instruction FIFO tap depth “Dt” of each of the variable depth instruction FIFOs [0] to [n] may be determined, as illustrated in FIG. 8. For example, for the variable depth instruction FIFO [0], D [0]=Tm and Dt [0]=D [0], as illustrated at 808. In particular, for RC-SIMD operation, Tm may refer to a time it takes a single processor core to access memory (e.g., complete memory access). For example, for the variable depth instruction FIFO [1], D [1]=Tm and Dt [1]=D [1], as illustrated at 810. For example, for the variable depth instruction FIFO [2], D [2]=Tm and Dt [2]=D [2], as illustrated at 812. For example, for the variable depth instruction FIFO [n], D [n]=Tm and Dt [n]=n/a as illustrated at 814. The value of D may correspond to a number of cache lines of a variable depth instruction FIFO. Each of the variable depth instruction FIFOs [0] to [n] in FIG. 8 may have substantially the same depths for RC-SIMD operation, as illustrated in FIG. 8. A depth of four may be determined based on the workload of FIG. 8, as illustrated in the variable depth instruction FIFOs [0] to [n] of FIG. 8.

Indeed, the value of D of a particular variable depth instruction FIFO for RC-SIMD operation may be determined to be the value of Tm, and the value of Dt may be the determined depth D. Furthermore, the value of D may be determined manually or automatically. For example, the depth “D” may be determined manually using Tm, for example, based on the memory access, the workload, an instruction stream, etc. As such, a user may be able to manually determine how many instructions may be needed for a particular workload, such as ten instructions, and that the ten instructions may take ten cycles, and that the depth may be ten. Once the depth is calculated for the particular variable depth instruction FIFO, other variable depth instruction FIFOs may be configured with that determined depth.

The depth may also be determined automatically. For example, a scheduling processor of FIG. 2 may set the depth of the variable depth instruction FIFO [0] to D [0]=1 (or this may be optional). Next, the scheduling processor may start running the instructions stream through the variable depth instruction FIFO [0] and into the processor core [0], and these instructions may be cascaded to the variable depth instruction FIFO [1]. The variable depth instruction FIFO [1] may be allowed to dynamically grow in size, storing the instructions from the variable depth instruction FIFO [0], until the processor core [0] is done using the data bus (or other shared resource). The scheduling processor may fix the depth of the variable depth instruction FIFO [1] at that point. Furthermore, the variable depth instruction FIFO [1] may pass instructions to the processor core [1], which may start executing instructions in the processor core [1], and the variable depth instruction FIFO [1] may also start cascading those same instructions to the variable depth instruction FIFO [2]. The scheduling processor may configure the variable depth instruction FIFO [2] and other the variable depth instruction FIFOs with the determined depth. As such, dynamically growing may occur once. However, the depth of the variable depth instruction FIFO [2] and other the variable depth instruction FIFO may be dynamically adjusted in the same manner.

Furthermore, there may be scenarios where dynamic tuning of individual variable depth instruction FIFO depths may be desired. For example, the variable depth instruction FIFO [n+1] may dynamically grow in size while processor core [n+1] is stopped, but the processor core [n] is running. The variable depth instruction FIFO [n+1] may dynamically shrink in size while processor core [n+1] is running, but the processor core [n] is stopped.

Of note, the determined depth may also function as a delay in RC-SIMD operation. For example, if the depth is determined to be four, the processor core [1] may receive an instruction four cycles after the processor core [0] received the instruction. Indeed, there may be a four cycle delay before the processor core [1] receives the instruction. As such, the processor core [1] may be delayed until the processor [0] is done with memory access.

Turning more specifically to FIG. 8, at a first cycle, an instruction (e.g., an add or a load instruction) may come into a cache line 818 of the variable depth instruction FIFO [0] via a tap 820. The cache line 818 may be a head of the variable depth instruction FIFO [0]. At a second cycle, the instruction may advance to cache line 822 in the variable depth instruction FIFO [0]. At a third cycle, the instruction may advance to cache line 824 in the variable depth instruction FIFO [0]. At a fourth cycle, the instruction may advance to cache line 826 in the variable depth instruction FIFO [0]. The cache line 826 may be the tail of the variable depth instruction FIFO [0].

At a fifth cycle, the instruction may pass from the variable depth instruction FIFO [0] to the processor core [0], as illustrated by 828. At the fifth cycle, the instruction may also be sent from the variable depth instruction FIFO [0] via the variable depth instruction FIFO tap 802 to cache line 830 of the variable depth instruction FIFO [1]. The cache line 830 may be a head of the variable depth instruction FIFO [1]. At a sixth cycle, the instruction may advance to cache line 832 in the variable depth instruction FIFO [1]. At a seventh cycle, the instruction may advance to cache line 834 in the variable depth instruction FIFO [1]. At an eighth cycle, the instruction may advance to cache line 836 in the variable depth instruction FIFO [1]. The cache line 836 may be the tail of the variable depth instruction FIFO [1].

At a ninth cycle, the instruction may pass from the variable depth instruction FIFO [1] to the processor core [1], as illustrated by 838. At the ninth cycle, the instruction may also be sent from the variable depth instruction FIFO [1] via the variable depth instruction FIFO tap 804 to cache line 840 of the variable depth instruction FIFO [2]. The cache line 840 may be a head of the variable depth instruction FIFO [2]. At an tenth cycle, the instruction may advance to cache line 842 in the variable depth instruction FIFO [2]. At a eleventh cycle, the instruction may advance to cache line 844 in the variable depth instruction FIFO [2]. At a twelfth cycle, the instruction may advance to cache line 846 in the variable depth instruction FIFO [2]. The cache line 846 may be the tail of the variable depth instruction FIFO [2].

At a thirteenth cycle, the instruction may pass from the variable depth instruction FIFO [2] to the processor core [2], as illustrated by 848. At the thirteenth cycle, the instruction may also be sent from the variable depth instruction FIFO [2] via the variable depth instruction FIFO tap 806 to cache line 850 of the variable depth instruction FIFO [n]. The cache line 850 may be a head of the variable depth instruction FIFO [n]. At a fourteenth cycle, the instruction may advance to cache line 852 in the variable depth instruction FIFO [n]. At a fifteenth cycle, the instruction may advance to cache line 854 in the variable depth instruction FIFO [n]. At a sixteenth cycle, the instruction may advance to cache line 856 in the variable depth instruction FIFO [n]. The cache line 856 may be the tail of the variable depth instruction FIFO [n]. At a seventeenth cycle, the instruction may pass from the variable depth instruction FIFO [n] to the processor core [n], as illustrated by 858.

Indeed, those of ordinary skill in the art may appreciate how the depths of each variable depth instruction FIFO may cause a delay (e.g., a four cycle delay) between the processor cores [0] to [n] for RC-SIMD operation. If the depth is different (e.g., different than four), then the delay may be different. Moreover, a variable depth instruction FIFO may be used to adjust timing of the instruction in order for the corresponding processor core to receive the instruction at the appropriate time. A variable depth instruction FIFO may also be used to cascade (e.g., distribute) the instruction to at least one other variable depth instruction FIFO, which may also adjust timing of the instruction and cascade the instruction and so on.

Furthermore, those of ordinary skill in the art may appreciate that the values determined for “D,” “Dt,” and/or a number of processor cores may be optimized to minimize resource contention in RC-SIMD operation. Indeed, some system resources, such as the data bus, may be used more completely with less contention for that resource. For example, the instruction execution in each processor core may be delayed by time “Tm” such that processor core [n+1] may not try to use the data bus until processor n is finished with it. And, the number of processor cores connected in this fashion may be selected such that the last processor core finishes using the data bus just in time for the first processor core to use the data bus for the next set of data.

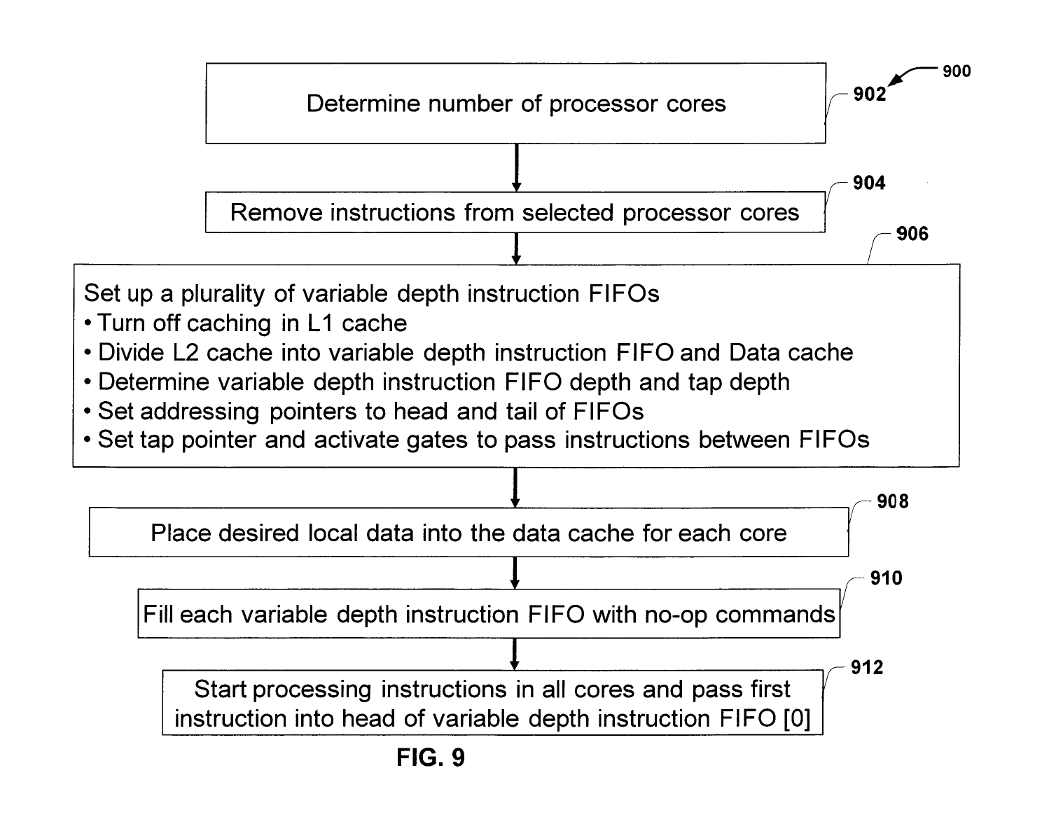

Turning to flowchart 900 of FIG. 9, FIG. 9 is a particular embodiment of a method of executing an instruction. The flowchart 900 of FIG. 9 may be executed by a scheduling processor, such as the scheduling core of the computer chip 202 of FIG. 2, the scheduling processor of the first computer 260 of FIG. 2, or the scheduling processor 268 of the second computer 262 of FIG. 2. The flowchart 900 may be applicable to SIMD operation, SIMD operation with staging, and RC-SIMD operation. Modifications may be made to the flowchart 900. For example, the order may be different, items may be added, items may be removed, etc.

At 902, the scheduling processor may determine a number of processor cores to use for a workload. For example, the scheduling processor may determine how many processor cores may be needed based on workload, how processor cores will access memory (e.g., SIMD operation, SIMD operation with staging, or RC-SIMD operation), etc. In particular, the scheduling processor may determine how many processor cores to use for RC-SIMD operation, as described herein in connection with FIG. 8 for RC-SIMD operation.

At 904, the scheduling processor may remove instructions from selected processor cores (e.g., quiesce those processor cores). For example, the scheduling processor may determine that four processor cores should be utilized, and instructions may be removed from the four processor cores selected.

At 906, the scheduling processor may set up a plurality of variable depth instruction. FIFOs. For each variable depth instruction FIFO, the scheduling processor may turn off caching in L1 cache, and divide L2 cache (or L1 or L3) into variable depth instruction FIFO and data cache, as described herein in connection with FIG. 2, 4, 5, 8.

For each variable depth instruction FIFO, the scheduling processor may also determine depth and tap depth, as described herein in connection with FIG. 2, 4, 5, 6, 8. Determining the depth and tap depth may include using the various equations described herein, for example, and may also include setting addressing pointers to head and tail of variable depth instruction FIFOs, as well as setting tap pointers and activating gates to pass instructions between the variable depth instruction FIFOs. For example, a variable depth instruction FIFO and data cache may be in a memory array. Indeed, there may be addresses for the tail and head of the variable depth instruction FIFO, an address for the instruction tap feeding the next FIFO, and an address for the next piece of data in the data cache. The memory array may not change, but addressing for reading and writing may change. Thus, addressing may be set (e.g., in registers) as appropriate. Indeed, setting tap points may include setting registers with addresses to be read from the memory array to pass to the next variable depth instruction FIFO. Moreover, a gate or multiplexor may be activated to allow an instruction to be passed from one variable depth instruction FIFO to another variable depth instruction FIFO. Precisely where the instruction enters a variable depth instruction FIFO may be based on the depth of the variable depth instruction FIFO.

At 908, the scheduling processor may place desired local data into each data cache. By doing so, cache misses may potentially be avoided. At 910, the scheduling processor may fill each variable depth instruction FIFO with no-op commands. For example, a corresponding processor core may be fetching instructions before it is passed the add or load instruction as described in FIGS. 2, 4, 5, 8, and therefore, each variable depth instruction FIFO may be filled with no-op commands.

At 910, processing of instructions may start in substantially all cores, and a first instruction may be passed into a head of a variable depth instruction FIFO [0] and cascaded. For example, the cores may process the no-op commands. The scheduling processor may pass the first instruction to the head of the variable depth instruction FIFO [0]. The first instruction may be cascaded from the variable depth instruction FIFO [0] to another variable depth instruction FIFO, as well as cascaded within the variable depth instruction FIFO [0] as described in FIGS. 2, 4, 5, 8.

Those of ordinary skill in the art may appreciate that by doing so, MIMD architecture may operate as SIMD architecture and SIMD type operation may be performed on the SIMD architecture. In particular, the variable depth instruction FIFOs may be utilized for SIMD operation and SIMD operation with staging, where instructions are executed at substantially the same time by each of the processors. The variable depth instruction FIFOs may also be utilized for reconfigurable single instruction multiple data (RC-SIMD) operation, where instructions are delayed between processors. In particular, the variable depth instruction FIFOs may be utilized to properly cascade (e.g., distribute) instructions within a particular variable depth instruction FIFO and cascade instructions to at least one other variable depth instruction FIFO. The variable depth instruction FIFOs may also be utilized to properly adjust timing of instructions for each processor core such that each processor core receives instructions at the appropriate time (e.g., substantially same time in SIMD operation and SIMD operation with staging or delayed with RC-SIMD operation).

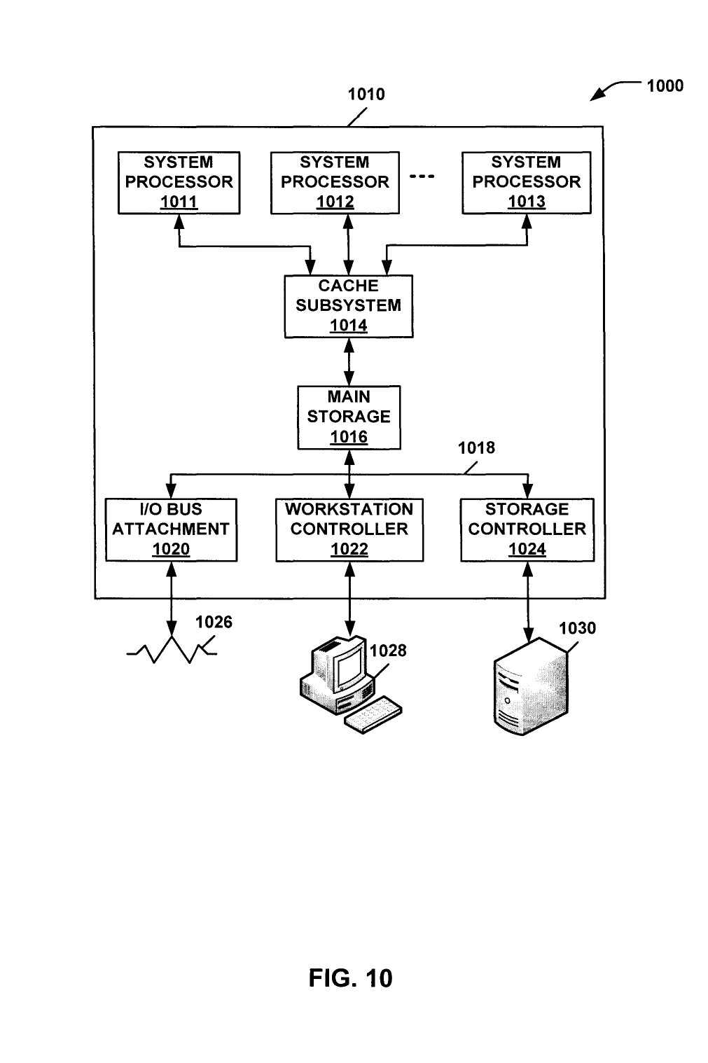

Turning to FIG. 10, FIG. 10 generally illustrates a data processing apparatus 1000 consistent with an embodiment. For example, the first computer 260 and/or the second computer 262 may be similar to the apparatus 1000. The apparatus 1000, in specific embodiments, may include a computer, a computer system, a computing device, a server, a disk array, client computing entity, or other programmable device, such as a multi-user computer, a single-user computer, a handheld device, a networked device (including a computer in a cluster configuration), a mobile phone, a video game console (or other gaming system), etc. The apparatus 1000 may be referred to as a logically partitioned computing system or computing system, but may be referred to as computer for the sake of brevity. One suitable implementation of the computer 1010 may be a multi-user computer, such as a computer available from International Business Machines Corporation (IBM).

The computer 1010 generally includes one or more physical processors 1011, 1012, 1013 coupled to a memory subsystem including a main storage 1016. The main storage 1016 may include one or more dual in-line memory modules (DIMMs). The DIMM may include an array of dynamic random access memory (DRAM). Another or the same embodiment may a main storage having a static random access memory (SRAM), a flash memory, a hard disk drive, and/or another digital storage medium. The processors 1011, 1012, 1013 may be multithreaded and/or may have multiple cores. A cache subsystem 1014 is illustrated as interposed between the processors 1011, 1012, 1013 and the main storage 1016. The cache subsystem 114 typically includes one or more levels of data, instruction and/or combination caches, with certain caches either serving individual processors or multiple processors.

The main storage 1016 may be coupled to a number of external input/output (I/O) devices via a system bus 1018 and a plurality of interface devices, e.g., an I/O bus attachment interface 1020, a workstation controller 1022, and/or a storage controller 1024 that respectively provide external access to one or more external networks 1026, one or more workstations 1028, and/or one or more storage devices such as a direct access storage device (DASD) 1030. The system bus 1018 may also be coupled to a user input (not shown) operable by a user of the computer 1010 to enter data (i.e., the user input sources may include a mouse, a keyboard, etc.) and a display (not shown) operable to display data from the computer 1010 (i.e., the display may be a CRT monitor, an LCD display panel, etc.). The computer 1010 may also be configured as a member of a distributed computing environment and communicate with other members of that distributed computing environment through a network 1026.

Particular embodiments described herein may take the form of an entirely hardware embodiment, an entirely software embodiment or an embodiment containing both hardware and software elements. In a particular embodiment, the disclosed methods are implemented in software that is embedded in processor readable storage medium and executed by a processor, which includes but is not limited to firmware, resident software, microcode, etc.

Further, embodiments of the present disclosure, such as the one or more embodiments may take the form of a computer program product accessible from a computer-usable or computer-readable storage medium providing program code for use by or in connection with a computer or any instruction execution system. For the purposes of this description, a non-transitory computer-usable or computer-readable storage medium may be any apparatus that may tangibly embody a computer program and that may contain, store, communicate, propagate, or transport the program for use by or in connection with the instruction execution system, apparatus, or device.

In various embodiments, the medium may include an electronic, magnetic, optical, electromagnetic, infrared, or semiconductor system (or apparatus or device) or a propagation medium. Examples of a computer-readable storage medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and digital versatile disk (DVD).

A data processing system suitable for storing and/or executing program code may include at least one processor coupled directly or indirectly to memory elements through a system bus. The memory elements may include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) may be coupled to the data processing system either directly or through intervening I/O controllers. Network adapters may also be coupled to the data processing system to enable the data processing system to become coupled to other data processing systems or remote printers or storage devices through intervening private or public networks. Modems, cable modems, and Ethernet cards are just a few of the currently available types of network adapters. The previous description of the disclosed embodiments is provided to enable any person skilled in the art to make or use the disclosed embodiments. Various modifications to these embodiments will be readily apparent to those skilled in the art, and the generic principles defined herein may be applied to other embodiments without departing from the scope of the disclosure. For example, an embodiment may include multiple processors connected to a single memory controller, either using separate processor busses from each processor to the memory controller, or using a single shared system bus that is connected to all processors and the memory controller. Thus, the present disclosure is not intended to be limited to the embodiments shown herein but is to be accorded the widest scope possible consistent with the principles and features as defined by the following claims.

1. A method, comprising:
creating a plurality of variable depth instruction FIFOs and a plurality of data caches from a plurality of caches corresponding to a plurality of processors, wherein the plurality of caches and the plurality of processors correspond to MIMD architecture; and
configuring the plurality of variable depth instruction FIFOs to implement SIMD architecture.

2. The method of claim 1, further comprising configuring the plurality of variable depth instruction FIFOs for at least one of SIMD operation, SIMD operation with staging, or RC-SIMD operation.

3. The method of claim 1, further comprising determining a depth for at least one variable depth instruction FIFO.

4. The method of claim 3, further comprising configuring at least one variable depth instruction FIFO with the determined depth.

5. The method of claim 3, further comprising configuring at least one variable depth instruction FIFO with a depth that is different than the determined depth.

6. The method of claim 3, further comprising determining the depth for at least one variable depth instruction FIFO by dynamically growing a variable depth instruction FIFO.

7. The method of claim 3, further comprising determining the depth for at least one variable depth instruction FIFO by dynamically shrinking a variable depth instruction FIFO.

8. The method of claim 1, further comprising determining a tap depth for at least one variable depth instruction FIFO.

9. The method of claim 1, further comprising determining a number of processor cores to utilize for a particular workload for a RC-SIMD operation.

10. The method of claim 1, further comprising configuring the plurality of variable depth instruction FIFOs to cascade an instruction, including configuring a first variable depth instruction FIFO to cascade the instruction within the first variable depth instruction FIFO and to cascade the instruction to a second variable depth instruction FIFO.

11. The method of claim 1, further comprising configuring the plurality of variable depth instruction FIFOs to adjust timing of an instruction to enable each processor core of the plurality of processor cores to receive the instruction at an appropriate time.

12. An apparatus, comprising:
a memory storing program code; and
a processor configured to access the memory and execute the program code to create a plurality of variable depth instruction FIFOs and a plurality of data caches from a plurality of caches corresponding to a plurality of processors, wherein the plurality of caches and the plurality of processors correspond to MIMD architecture, and to configure the plurality of variable depth instruction FIFOs to implement SIMD architecture.

13. The apparatus of claim 12, wherein the processor is configured to execute the program code to configure the plurality of variable depth instruction FIFOs for at least one of SIMD operation, SIMD operation with staging, or RC-SIMD operation.

14. The apparatus of claim 12, wherein the processor is configured to execute the program code to determine a depth for at least one variable depth instruction FIFO.

15. The apparatus of claim 14, wherein the processor is configured to execute the program code to determine the depth for at least one variable depth instruction FIFO by dynamically growing a variable depth instruction FIFO.

16. The apparatus of claim 12, wherein the processor is configured to execute the program code to determine a tap depth for at least one variable depth instruction FIFO.

17. The apparatus of claim 12, wherein the processor is configured to execute the program code to determine a number of processor cores to utilize for a particular workload for RC-SIMD operation.

18. The apparatus of claim 12, wherein the processor is configured to execute the program code to configure the plurality of variable depth instruction FIFOs to cascade an instruction, including configuring a first variable depth instruction FIFO to cascade the instruction within the first variable depth instruction FIFO and to cascade the instruction to a second variable depth instruction FIFO.

19. The apparatus of claim 12, wherein the processor is configured execute the program code to configure the plurality of variable depth instruction FIFOs to adjust timing of an instruction to enable each processor core of the plurality of processor cores to receive the instruction at an appropriate time.

20. An apparatus, comprising:
a plurality of variable depth instruction FIFOs and a plurality of data caches created from a plurality of caches corresponding to a plurality of processors, including a first variable depth instruction FIFO, a second variable depth instruction FIFO, and a third variable depth instruction FIFO, and wherein the plurality of caches and the plurality of processors correspond to MIMD architecture;
the first variable depth instruction FIFO configured to cascade an instruction within the first variable depth instruction FIFO and to cascade the instruction to the second variable depth instruction FIFO to implement SIMD architecture; and
the second variable depth instruction FIFO configured to cascade the instruction within the second variable depth instruction FIFO and to cascade the instruction to a third variable depth instruction FIFO to implement SIMD architecture.
